(19) United States
(12) Patent Application Publication
(10) Pub. No.: US 2010/0171477 A1
(43) Pub. Date: Jul. 8, 2010

(54) Power supply device and electronic apparatus

(75) Inventors: Yoshito Koyama, Kawasaki (JP); Minoru Hirahara, Kawasaki (JP); Seiji Miyoshi, Kawasaki (JP); Eiji Miyachika, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/659,700

(22) Filed: Mar. 17, 2010

Related U.S. Application Data
(63) Continuation of application No. PCT/JP2007/068195, filed on Sep. 19, 2007.

(51) Int. Cl. G05F 1/10

(52) U.S. Cl. 323/282

(57) ABSTRACT

A power supply device includes a first supply section that supplies power according to an extent of a collective load of processing in a processing apparatus for the whole of the processing apparatus which processes data, and further includes a second supply section that supplies, at a place on a supply path through which power is supplied from the first supply section to the processing apparatus, power according to an extent of a load of processing in local in a portion of the processing apparatus to the portion, and supplies power smaller than supplying power of the first supply section.

### CROSS-REFERENCE TO RELATED APPLICATION

This is a continuation application of PCT/JP2007/068195, filed on Sep. 19, 2007.

### TECHNICAL FIELD

The present invention relates to a power supply device which supplies power to a processing device and an electronic apparatus provided with the power supply device.

### BACKGROUND ART

Conventionally, in an electronic apparatus such as a communication apparatus and a server apparatus, a power supply device which supplies electrical power to an IC or the like which performs various kinds of processes. It is always required to stably supply electrical power to the electrical power device, particularly to constantly adjust an output voltage outputted to an IC or the like.

FIG. 1 is a schematic diagram of a power supply device to supply electrical power to an electronic device.

A power supply device 10 illustrated in FIG. 1 is an analogue control type power supply device which controls an output voltage to an IC and the like using an analogue element such as an amplifier and a comparator.

The power supply device 10 is provided with a voltage detecting circuit 11, an error amplifying device 12, a compensation circuit 13, a reference oscillator 14, a comparator 15, a switch element 16, a smoothing filter 17 and the like.

Firstly, in the voltage detecting circuit 11, a power supply output voltage Vout which is at the current time outputted from the power supply device 10 to an IC or the like is detected, the detected output voltage Vout is transmitted to the error amplifying device 12. In the error amplifying device 12, a difference between the output voltage Vout and a reference voltage V0 is amplified to be outputted. In the compensation circuit 13, an amplified voltage Vg outputted from the error amplifying device 12 is adjusted to a value appropriate for a sensitivity of the comparator 15.

In the reference oscillator 14, a voltage signal Vp of a sawtooth waveform is outputted at a given frequency. In the comparator 15, the voltage signal Vp of the sawtooth waveform outputted from the reference oscillator 14 is compared to the amplified voltage Vg adjusted in the compensation circuit 13, and a control signal, which becomes “ON” while the voltage signal Vp of the sawtooth waveform is smaller than the amplified voltage Vg and which becomes “OFF” in other time, is transmitted to the switch element 16.

In the switch element 16, ON/OFF control is performed by the control signal transmitted from the comparator 15 so that a pulse width of an input voltage Vin inputted to the power supply device 10 is adjusted and smoothing processing is performed in the smoothing filter 17. As a result, the output voltage Vout whose voltage is adjusted is outputted from the power supply device 10 to the electronic apparatus. For example, if the output voltage Vout detected in the voltage detecting circuit 11 becomes low, an error between the output voltage Vout calculated in the error amplifying device 12 and the reference voltage V0 becomes large. As a result, the voltage signal Vp of the sawtooth waveform becomes smaller than the amplified voltage Vg and the “ON” time duration of the control signal outputted from the comparator 15 becomes long and a pulse width of the input voltage Vin is adjusted to be long so that the output voltage Vout increases.

In the power supply device 10, as described above, an output voltage to be outputted to a processing section is controlled to be constant.

Here, in the electronic apparatus, each of various components, an IC and the like which are included in the electronic apparatus is supplied with electrical power to operate. In these components, the IC and the like, electrical power consumption changes according to an extent of a load in processing shared by each of these components, the IC and the like. If such individual load changes of respective components are slow, an application voltage to be applied to the various components, the IC and the like is kept to be constant by a collective whole control with a single power supply device through absorbing a load change in the various components, the IC and the like so that it is possible to continuously supply required electrical power. However, in a communication apparatus, a server apparatus and the like of electronic apparatuses, there may be a case where, a load in an IC or the like abruptly changes corresponding to a traffic state of communication. Thus, by a collective whole control with a single power supply device, it is difficult to absorb an abrupt load change in such a local place.

For this reason, there is proposed a technique (see, U.S. Pat. No. 6,646,425) in which plural power supply devices similar to one described above are prepared, one or more of such power supply devices are arranged in a periphery of each of various kinds of components, an IC or the like, with these plural power supply devices arranged in the periphery, a voltage to be applied to each of the various kinds of components, the IC or the like is individually controlled so that a load change in local is absorbed individually and to supply required electrical power is controlled individually.

However, even though by the technique disclosed in U.S. Pat. No. 6,646,425, a voltage applied to each of the various kinds of components, the IC or the like is controlled individually, if a load change in a component or the like adjacent to a control target of a power supply device is too large, there frequently occurs a problem that to supply electrical power proper to its own control target may not be maintained, by being influenced by a load change in a component other than its own control target.

In view of the foregoing, it is an object in one aspect of the present invention to provide a power supply device which is capable of favorably supplying electrical power to each of various kinds of components, an IC or the like included in an electronic apparatus, and an electronic apparatus provided with such power supply device.

### DISCLOSURE OF THE INVENTION

A power supply device according to one aspect of the invention to obtain the object described above, includes:

a first supply section that supplies power according to an extent of a collective load of processing in a processing apparatus for the whole of the processing apparatus which processes data; and

a second supply section that supplies, at a place on a supply path through which power is supplied from the first supply section to the processing apparatus, power according to an extent of a load of processing in local in a portion of the processing apparatus to the portion, and supplies power smaller than supplying power of the first supply section.

According to this power supply device according to the one aspect of the invention, even if a large load change which may cause an influence to a power supply control for another process section in local processing in the above-described processing device occurs, almost of this change may be absorbed by a power supply control as a whole by the above-described first supply section whose supplying power is a relatively large capacity. Thanks to this, a local power control by the above-described second supply section is prevented from an influence received from a load change in a processing section other than the processing section which is an object to be supplied with power by the second supply section, and the local power control by each of the second supply section is normally performed. That is, according to the power supply device of the present invention, power supplying to various kinds of components, an IC or the like included in an electronic apparatus (a processing apparatus) may be performed preferably.

Here, in the power supply device according to the aspect of the present invention, it is a preferable mode that “the processing apparatus includes plural processing sections each performing processing, and the second supply section forms plural groups which are associated with the plural processing sections respectively and supply power to the plural processing sections, respectively, and the second supply sections which are included in the groups being different from each other are coupled to each other electrically more weakly than the second supply sections which are included in a same group.”

According to this preferable mode of the power supply device, because the second supply sections included respectively in the above-described groups being different to each other are electrically weakly coupled to each other, in a power control in local by a certain group, reception of an influence from a load change in another processing section to which power is supplied from another group is further suppressed.

In addition, in the power supply device according to the aspect of the invention, it is a preferable mode that “the first supply section and the second supply section are arranged separately on a top face and a bottom face of one single board.”

According to this preferable mode of the power supply device, because it is possible to independently arrange the first supply section and the second supply section, it is possible to arrange a supply section without being interfered by an arrangement of another supply section.

In addition, an aspect of an electronic apparatus to obtain the above-described object includes:

a processing device that processes data, and

a power supply device that includes:
a first supply section that supplies power according to an extent of a collective load of processing in a processing apparatus for the whole of the processing apparatus which processes data; and
a second supply section that supplies, at a place on a supply path through which power is supplied from the first supply section to the processing apparatus, power according to an extent of a load of processing in local in a portion of the processing apparatus to the portion, and supplies power smaller than supplying power of the first supply section.

According to the electronic apparatus of the aspect of the present invention, it is possible to perform power supplying preferably for each of various kinds of components, an IC or the like included in the electronic apparatus.

Incidentally, for the electronic apparatus according to the invention, only this basic aspect is described here. It is simply for avoiding another overlapping description. However, in the electronic apparatus according to the invention, not only the above-described basic aspect but also aspects corresponding to respective modes of the above-described power supply device are included.

According to the present invention, it is possible to obtain a power supply device which may preferably perform power supplying to each of various kinds of components, an IC or the like, and an electronic apparatus mounted with such power supply device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a schematic diagram of a power supply device which supplies electrical power to an electronic apparatus.

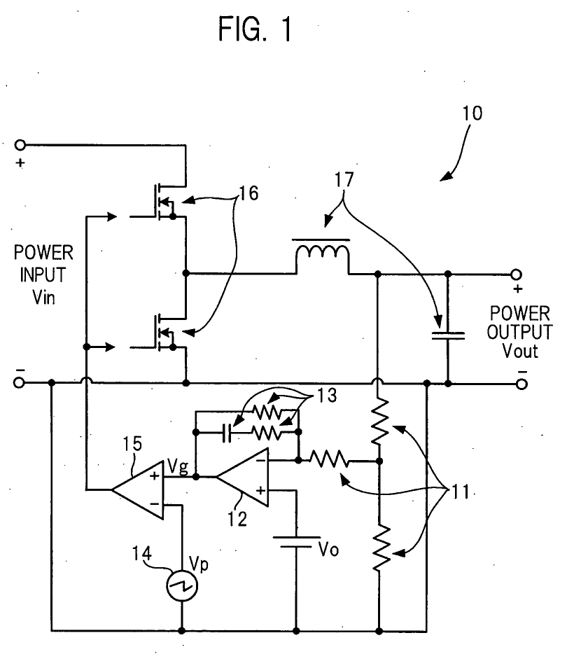

FIG. 2 is an external perspective view of a communication unit to which one aspect of the invention is applied.

FIG. 3 is a schematic diagram of a holding plate 210 included in an electronic circuit package 200.

FIG. 4 is a schematic diagram of the electronic circuit package 200 in which a board 220 is attached to the holding plate 210.

FIG. 5 is schematic functional block diagram of three electronic circuit packages 200_1, 200_2 and 200_3 of plural electronic circuit packages 200 illustrated in FIG. 2.

FIG. 6 is a diagram to explain a flow of power supply in a signal processing package 200_3.

FIG. 7 is a schematic constitutional diagram of a processing circuit 228, an OBP 227 which supplies electrical power to the processing circuit 228 and a power control section 226_3 also illustrated in FIG. 5.

FIG. 8 is a diagram illustrating an appearance in which a large OBP and small OBP's are mounted together on a same plane of a board.

### BEST MODE FOR CARRYING OUT THE INVENTION

In the following, embodiments according to the invention will be explained with reference to the drawings.

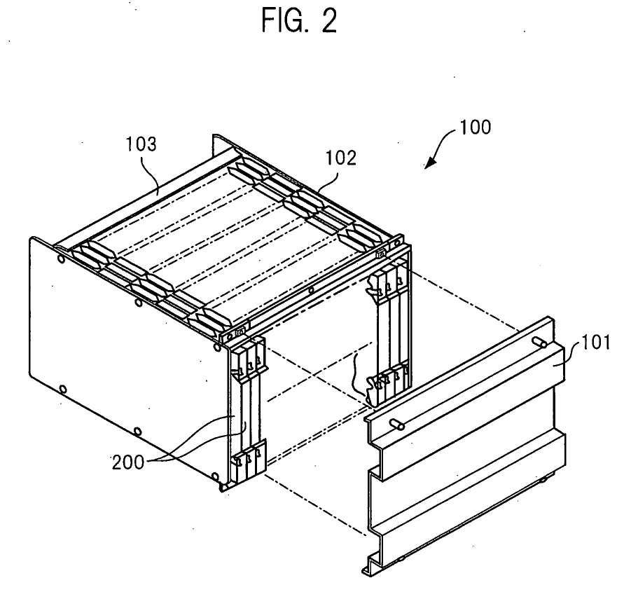

FIG. 2 is an external perspective view of a communication unit to which one aspect of the invention is applied.

This communication unit 100 corresponds to an example of the electronic apparatus according to the invention. The communication unit 100 performs sending and receiving data via a network. The communication unit 100 includes an unit cover 101, an unit frame 102, a back panel 103 and plural electronic circuit packages 200 which perform processing, housed in a space surrounded by the cover 101, the unit frame 102 and the back panel 103.

On an inside of the back panel 103, there are provided various kinds of connectors (not illustrated) to transfer data or electrical power. These connectors are engaged with connectors arranged in the plural electronic circuit packages 200, respectively, so that the plural electronic circuit packages 200 are connected with each other.

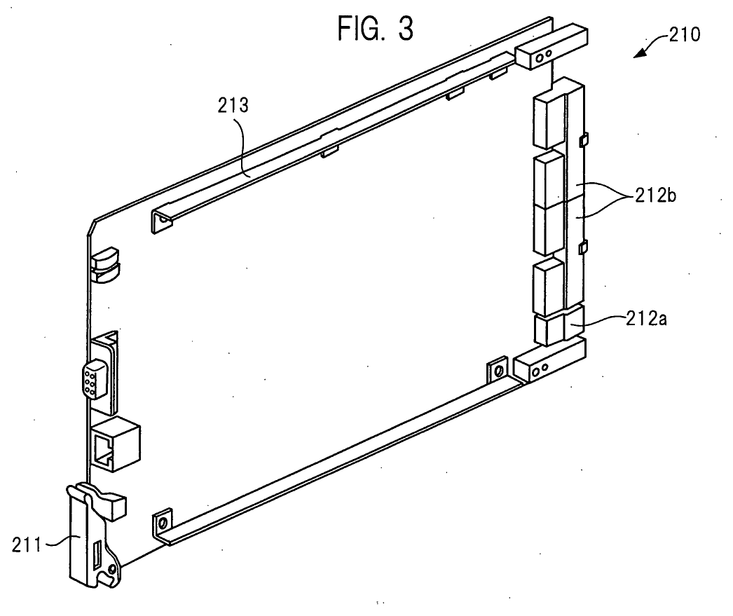

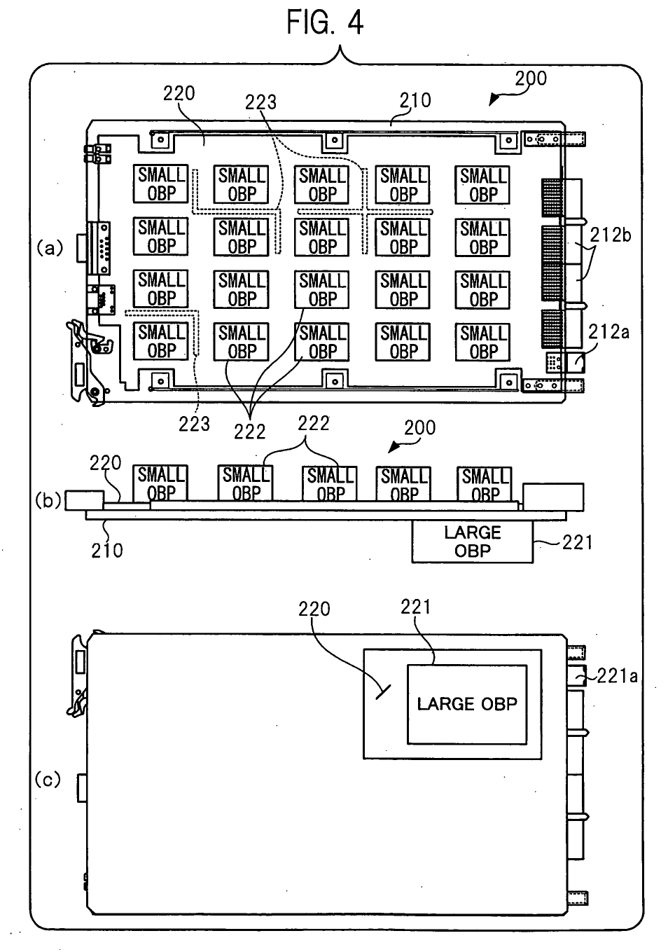

The plural electronic circuit packages 200 perform processing sequentially for communication data sent via the network, where in response to processing performed in an upstream electronic circuit package 200, processing in a downstream electronic circuit package 200 is started. In addition, each of the plural electronic circuit packages 200 includes a board 220 (see, FIG. 4) to which an IC or the like is attached and the holding plate 210 (see FIG. 3) which holds the board 220.

FIG. 3 is a schematic diagram of the holding plate 210 included in the electronic circuit package 200. FIG. 4 is a schematic diagram of the electronic circuit package 200 in which the board 220 is attached to the holding plate 210.

The holding plate 210 is provided with a grasp section 211 which is grasped by a hand when the holding plate 210 is inserted and extracted to and from the unit frame 102 in FIG. 2, a power connector 212a to input electrical power to the electronic circuit package 200, a curve preventing metal member 213 to prevent curving of the board 220, a data connector 212b to send and receive various kinds of data and the like.

In FIG. 4, the electronic circuit package 200 is illustrated in a state where the board 220 is attached to the holding plate 210. In part (a) of FIG. 4, a top view of the electronic circuit package 200 is illustrated. In part (b) of FIG. 4, a side view of the electronic circuit package 200 is illustrated. In part (c) FIG. 4, a bottom view of the electronic circuit package 200 is illustrated.

The board 220 is provided with plural processing circuits such as an IC and the like. However, illustration of them is omitted in FIG. 4. In addition, the board 220 is provided with a relatively large capacity power supply source (large OBP) 221 which supplies relatively large power to the collective whole of plural processing circuits and plural relatively small capacity power supply sources (small OBP) 221 which supply relatively small power to respective processing circuits at places on a supply path through which power is supplied to each of the processing circuits from the large OBP 221. In other words, power supplied to each of the processing circuits is electrical power which the large OBP 221 and electrical power from the small OBP's 222 cooperatively output. Here, the small OBP's 222 are distributedly arranged in a top face of the board 220 as illustrated in part (a) of FIG. 4 such that one or more of the small OBP's 222 are arranged side-by-side near a processing circuit not illustrated. As illustrated in part (c) of FIG. 4, the large OBP 221 is arranged in a periphery of the power supply connector 212a on a bottom face of the board 220. Here, the large OBP 221 and the small OBP's 222 correspond to examples of the first supply section and the second supply sections according to the invention, respectively.

In addition, in the present embodiment, because the large OBP 221 and the small OBP 222 are separately arranged on the top and bottom surfaces respectively, the large OBP 221 having a large capacity and being large in size, and the small OBP's 222 each having a small capacity and being small in size whereas many in number are appropriately arranged without interfering with their arrangements to each other.

In addition, in the board 220, a power supply layer (not illustrated) is provided to parallelly connect outputs of the large OBP 221 and the plural small OBP's 222 to each other. In this power supply layer, a slit 223 illustrated in part (a) of FIG. 4 is provided. Here, around each processing circuit, one or more of the small OBP's 222 which supply electrical power to each processing circuit are arranged and form groups. The slit 223 is provided between groups adjacent to each other so that the small OBP's 222 which belong to different groups are coupled to each other electrically more weakly than the small OBP's which belong to a same group.

This board 220 is engaged in the holding plate 210 and the power source connector 212a and the data connector 212b of the holding plate 210 are inserted into the board 220 so that the board 220 is attached to the holding frame 210. Further, the holding plate 210 is engaged in the unit frame 102 illustrated in FIG. 2 to be connected to connectors of a back panel 102 so that plural electronic circuit packages 200 are connected to each other.

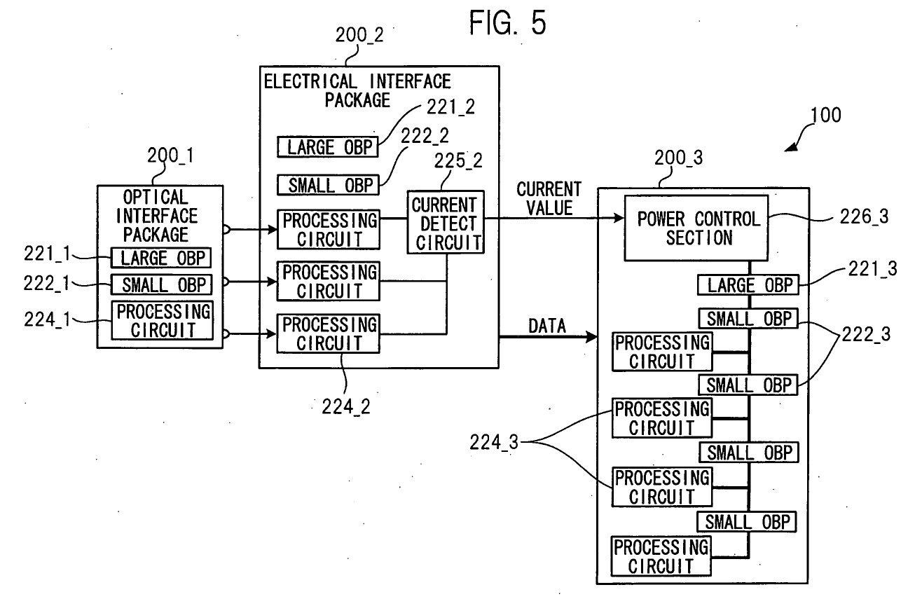

FIG. 5 is a schematic functional block diagram of three electronic circuit packages 200_1, 200_2 and 200_3 of plural electronic circuit packages 200 illustrated in FIG. 2.

Incidentally, in the following, various kinds of elements included in the respective three electronic circuit packages 200_1, 200_2, 200_3 are distinguished from each other by the numeric attached as the suffix to be explained.

In FIG. 5, an optical interface package 200_1, an electrical interface packages 200_2 and a signal processing package 200_3 are illustrated. The optical interface package 200_1 receives optical data sent via a network. The electrical interface packages 200_2 converts the optical data received by the optical interface package 200_1 to digital data. The signal processing package 200_3 subjects various kinds of processes to the digital data converted by the electrical interface package 200_2. In the present embodiment, electrical power is inputted to the whole of the communication unit 100 illustrated in FIG. 2. After the electrical power is distributed to each of the large OBP 221 and the small OBP's 222, in each electronic circuit package 200, electrical power is supplied collectively to the plural processing circuits 224 from the large OBP 221, and electrical power is supplied in local to each of the processing circuits 224. These plural processing circuits 224 collectively correspond to an example of the processing device according to the invention.

The electrical interface package 200_2 is provided with a current detect circuit 225_2 to detect a value of a current which flows into the processing circuit 224_2 at the time of processing. The signal processing package 200_3 is provided with a power control section 226_3 which obtains the current value detected by the current detect circuit 225_2 of the electrical interface package 200_2 and controls power supply in both the large OBP 221_3 and the small OBP's 222_3 according to the obtained current value.

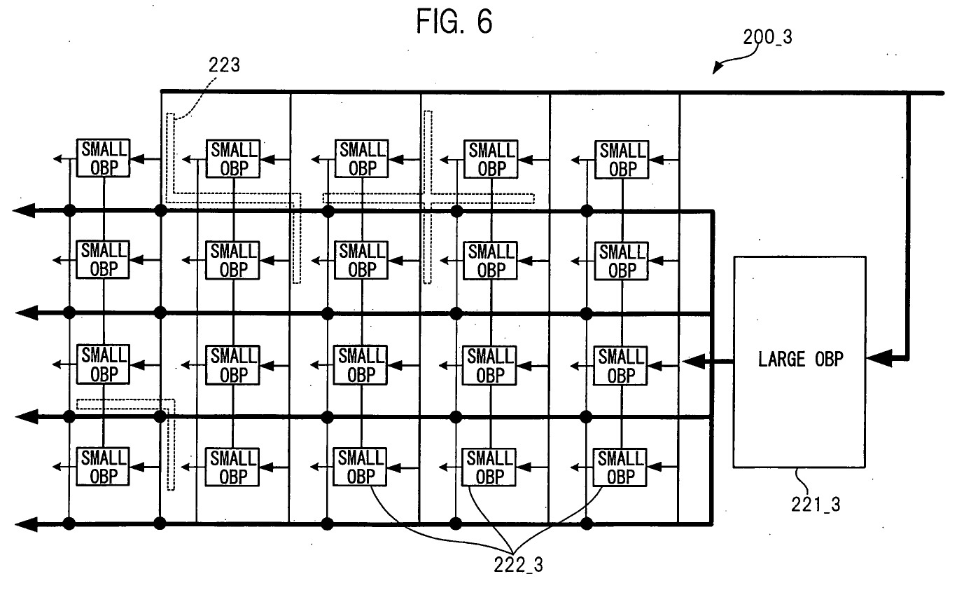

FIG. 6 is a diagram to explain a flow of power supply in the signal processing package 200_3. Incidentally, with respect to the power control section 226_3 and the plural processing circuit 224_3 illustrated in FIG. 5, illustration of them is omitted in order to make the drawing be easily viewed, and only the large OBP 221_3 and the plural small OBP's 222_3 are illustrated.

In FIG. 6, the right side of the drawing corresponds to an upstream side of a flow of power supply, and the left side of the drawing corresponds to a downstream side. In each of the processing circuits 224_3 in FIG. 5 provided in the signal processing package 200_3, a power source terminal to which electrical power is inputted is connected to the power supply layer and each of the processing circuits 224_3 is supplied with electrical power from this power supply layer. The large OBP 221_3 applies voltage by relatively large electrical power to the power supply layer in the most upstream side of the flow of power supply. Each of the processing circuits 224_3 receives relatively large electrical power through the voltage application to the power supply layer by this large OBP 221_3.

Here, if a load changes in the processing circuit 224_3, a current flowing into that processing 224_2 changes, and as a result, the application voltage of that processing circuit 224_3 is going to change.

In the present embodiment, the large OBP 221_3 controls a voltage to be applied to the power supply layer by controlling of the power control section 226_3 in FIG. 5 so as to suppress a change of an average of the application voltage among plural of the processing circuits 224_3. In other words, the large OBP 221_3 supplies, by such control of the application voltage, electrical power according to an extent of a load as a whole of processing in the signal processing package 200_3. However, the control of the large OBP 221_3 is only performed averagedly, and a speed of the control is small because the large OBP 221_3 has a large capacity, and a fast voltage change according to a load change of each processing circuit 224_3 may not be suppressed by the large OBP 221_3.

Thus, in order to locally suppress such fast voltage change for each of the processing circuits 224_3 to supply required electrical power to each of the processing circuits 224_3, the small OBP's 222_3 each having a relatively small capacity are arranged to apply a voltage to the power supply layer in a periphery of each processing circuit 224_3. Each small OBP 222_3 controls an application voltage so as to suppress a change of the application voltage by a load change in a target processing circuit 224_3 to be supplied with power. As described, because the control by each of the small OBP's 222_3 is a control for the application voltage of each of the processing circuits 224_3 and the small OBP's 222_3 has a small capacity, a speed of the control is large. Therefore, it is possible to securely suppress a fast voltage change for each of the processing circuits 224_3 whose fast voltage change may not be suppressed by the large OBP 221_3 so as to maintain required power supply. On the other hand, because the small OBP's are small in capacity, if there is a large load change in a processing circuit 224_3 other than a processing circuit 224_3 as a control target and a large voltage change in electrical power occurs in the power supply layer, it is impossible for the small OBP's 222_3 to properly control the application voltage. However, because such large voltage change in electrical power is slow in speed of the change, it is possible to sufficiently suppress such large voltage change in electrical power through the control of the large OBP 221_3. As described, in the present embodiment, the control by the large OBP 221_3 and the control by the small OBP's 222_3 compensate with each other to control a voltage of the power supply layer to be constant, so that power supply for each of the processing circuits 224_3 is preferably maintained.

In addition, in the present embodiment, as explained with reference to FIG. 4, the slit 223 is provided in the power supply layer. As described above, in a periphery of each of the processing circuits 224_3, one or more of the small OBP's 222 which supply power to each of the processing circuits 224_3 is provided and form groups. The slit 223 is arranged between groups adjacent to each other such that small OBP's belonging to different groups couple electrically more weakly than small OBP's belonging to a same group. Thanks to this slit, an electrical resistance between the small OBP's 222 belonging to the different groups becomes larger than that between the small OBP's 222 belonging to the same group, and a voltage change of the power supply layer by a load change in the processing circuit 224_3 to which electrical power is supplied by a certain group difficultly propagate to another group, and so it becomes easier to locally control a voltage change by the small OBP's 222.

Next, s control of an application voltage in the large OBP 221_3 and the small OBP's 222_3 will be explained in detail. Incidentally, in the large OBP 221_3 and the small OBP's 222_3, since the control method itself is common between them, in the following, a reference “227” is attached to a simple OBP without differentiating large or small in the drawings to provide an explanation. In addition, a processing circuit supplied with electrical power by this OBP 227 is illustrated as being attached with a reference “228” in the following drawings.

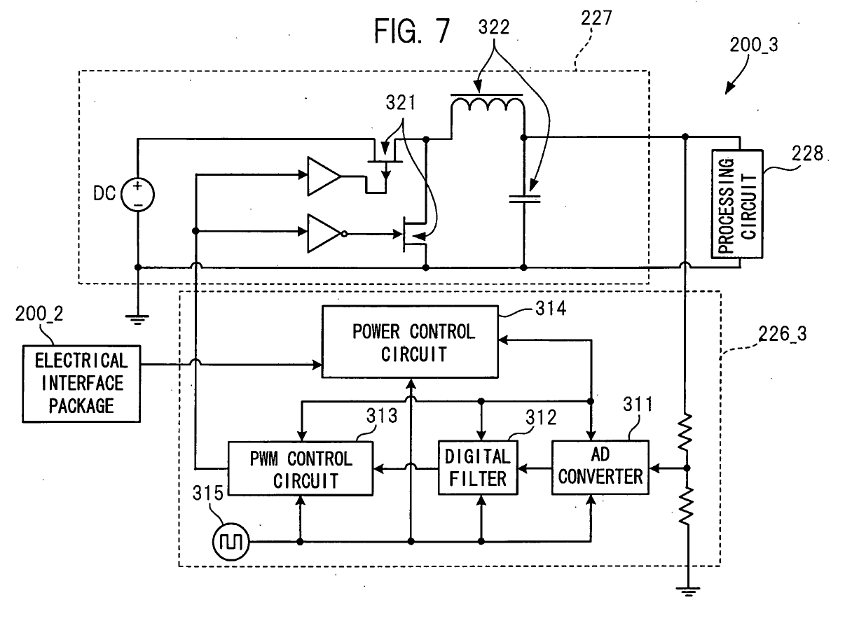

FIG. 7 is a schematic diagram of the processing circuit 228, the OBP 227 which supplies electrical power to the processing circuit 228 and the power control section 226_3 also illustrated in FIG. 5.

Incidentally, in order to simplify the explanation, it is supposed here that the processing circuit 228 is supplied with power from a singly OBP 227.

As illustrated in FIG. 7, the power control section 226_3 is provided with an AD (analogue-digital) converter 311, a digital filter 312, a PWM control circuit 313, a power control circuit 314 and a pulse generator 315. The OBP 227 is provided with a switch element 321, a smoothing filter 322 and the like.

In controlling supply power to the processing circuit 228, similar to a conventional power supply device basically, based on an electrical power which has been supplied before the current time point, a feedback process to control for an electrical power to be supplied after the current time point is performed.

Firstly, in the AD converter 311, a voltage applied to the processing circuit 228 from the OBP 227 before the current time point is detected, and the detected voltage is converted to a digital signal to be transmitted to the digital filter 312. In the digital filter 312, a difference between the detected voltage and a reference voltage set in advance is calculated, and the difference is averaged to generate an error signal. Here, with respect to the large OBP, in the digital filter 312, an average value of application voltages detected respectively with respect to plural processing circuits 227 is calculated, and the error signal described above is generated using the average value.

The error signal generated by the digital filter 312 is transmitted to the PWM control circuit 313.

In the PWM control circuit 313, based on a pulse signal transmitted from the pulse generator 315 and the error signal transmitted from the digital filter 312, a control signal with a pulse width according to a control value transmitted from the control circuit 314 is generated, and the generated control signal is transmitted to the switch element 321.

In the switch element 321, ON/OFF is controlled according to the control signal transmitted from the PWM control circuit 313, and, as a result, a pulse width of an input voltage is adjusted. Further, the voltage whose width is adjusted is passed through the smoothing filter 322, so that an application voltage is smoothed to supply electrical power to the processing circuit 228.

For example, if an application voltage drops, a value of the error signal generated in the digital filter 312 becomes large, and thus, a control signal with a large pulse width is generated in the power control circuit 314. As a result, a “ON” time of the switch element 321 becomes longer and the application voltage increases. As described above, power supplied to the processing circuit 228 is adjusted by the feedback control.

In addition, in the present embodiment, a value of a current flowing into the processing circuit 221_2 of an electrical interface package 200_2 from one in the upstream side is transmitted to the power control circuit 314. In general, as an amount of communication data as a processing target increases, a load of the processing increases, and thus, it is common that a large current flows into the processing circuit. The value of the current flowing into the electrical interface package 200_2 in the upstream side is informed, so that a load of processing to be performed from now on in a processing circuit 228 may be predicted.

The power control circuit 314 causes the AD converter 311 to reduce the detected voltage more, as the current value obtained from the electrical interface package 200_2 is larger, and causes the digital filter 312 to apply the reference voltage smaller, as the obtained current value is larger, and causes the PWM control circuit 313 to increase a pulse width of the control signal more as the obtained current value is larger. As a result, the application voltage by the OBP 227 increases.

As described, according to the present embodiment, based on electrical power which has been supplied before the current time point, electrical power to be supplied after the current time point is adjusted (feedback control), and power supply is adjusted according to a load of processing in the electrical interface package 200_2 in the upstream side (feedforward control). Accordingly, it is possible to stably supply electrical power to a processing circuit, and it is possible to reduce defects caused by a load increase of processing. In addition, as described above, in the present embodiment, the large OBP 221_3 with a relatively large capacity and the small OBP's 222_2 with relatively small capacities compensate with each other so that it is possible to preferably supply electrical power to each of the processing circuits.

Incidentally, an example in which the large OBP and the small OBP's are mounted separately on a top face and a bottom face of a board respectively is described as illustrated in FIG. 4. However, the present invention is not limited to this. These two kinds of OBP's may be mounted on a same face of a board as described in the following.

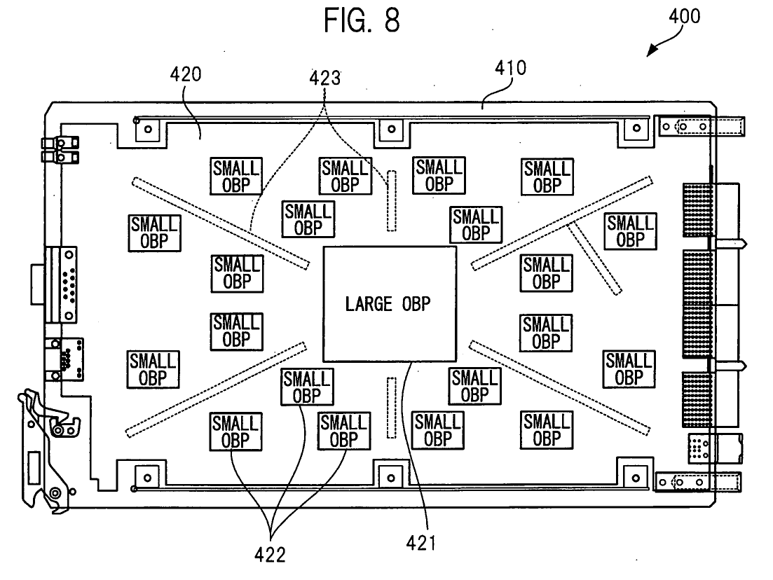

FIG. 8 is a diagram illustrating an appearance in which the large OBP and the small OBP's are mounted together on a same face of a board.

In FIG. 8, an electronic circuit package 400 in which a board 420 on a top face of which a large OBP 421 and small OBP's 422 are mounted together is engaged in a holding plate 410. In this example of FIG. 8, the large OBP 421 is arranged in a center of the board 420. In addition, processing circuits not illustrated in the drawing are distributedly arranged in a periphery of the large OBP 421. Following this arrangement, the small OBP's are distributedly arranged in a periphery of the large OBP 421.

Also in this example of FIG. 8, a voltage apply point to the power supply layer from the large OBP 421 is mostly upstream on a power supply path in the power supply layer, and the small OBP's 422 apply voltages to the power supply layer at places on the power supply path.

In addition, also in the example of FIG. 8, plural small OBP's 422 which supply electrical power to respective processing circuits different from each other form groups. A slit 423 is arranged between groups adjacent to each other in the power supply layer such that small OBP's 422 which belong to different groups are coupled electrically more weakly than small OBP's 422 which belong to a same group.

In the example of FIG. 8, although the arrangement is restricted comparing to the example of FIG. 4 described above because the large OBP 421 and the small OBP's 422 are arranged in a same face of the board 420, the large OBP 421 having a relatively large capacity and the small OBP's 420 each having a relatively small capacity compensate with each other, so that it is possible to preferably perform power supply for each of the processing circuits, similarly to the embodiment of FIG. 4.

Incidentally, in the description above, an example is explained in which increase and decrease of a voltage applied to the processing circuits via the power supply layer is adjusted so that electrical power applied to the processing circuits is controlled. However, the first supply section and the second supply section according to the present invention may control electrical power supplied to the processing circuit by adjusting an amount of a current supplied to the processing circuits.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A power supply device, comprising:
a first supply section that supplies power according to an extent of a collective load of processing in a processing apparatus for the whole of the processing apparatus which processes data; and
a second supply section that supplies, at a place on a supply path through which power is supplied from the first supply section to the processing apparatus, power according to an extent of a load of processing in local in a portion of the processing apparatus to the portion, and supplies power smaller than supplying power of the first supply section.

2. The power supply device according to claim 1, wherein
the processing apparatus includes a plurality of processing sections each performing processing, and
the second supply section forms a plurality of groups which are associated with the plurality of processing sections respectively and supply power to the plurality of processing sections, respectively, and the second supply sections which are included in the groups being different from each other are coupled to each other electrically more weakly than the second supply sections which are included in a same group.

3. The power supply device according to claim 1, wherein the first supply section and the second supply section are arranged separately on a top face and a bottom face of one single board.

4. An electronic apparatus, comprising:
a processing device that processes data, and
a power supply device that includes:
a first supply section that supplies power according to an extent of a collective load of processing in a processing apparatus for the whole of the processing apparatus which processes data; and
a second supply section that supplies, at a place on a supply path through which power is supplied from the first supply section to the processing apparatus, power according to an extent of a load of processing in local in a portion of the processing apparatus to the portion, and supplies power smaller than supplying power of the first supply section.
